(19) United States
(12) Patent Application Publication
(10) Pub. No.: US 2009/0194272 A1
(43) Pub. Date: Aug. 6, 2009

(54) APPARATUS AND METHOD FOR TREATING INJECTION FLUID

(75) Inventor: Brian Baillie, Glasgow (GB)

Correspondence Address: GIFFORD, KRASS, SPRINKLE,ANDERSON & CITKOWSKI, P.C, PO BOX 7021, TROY, MI, 48007-7021, US

(73) Assignee: VWS Westgarth Limited, East Kilbride (GB)

(21) Appl. No.: 12/304,480

(22) PCT Filed: Jun. 12, 2007
(86) PCT No.: PCT/GB2007/002159

§ 371 Date: Apr. 10, 2009

(30) Foreign Application Priority Data
Jun. 14, 2006 (GB) 0611710.5

(51) Int. Cl. E21B 43/20; E21B 43/00; C02F 1/44; C02F 1/42; C02F 1/02; C02F 9/02

(52) U.S. Cl. 166/90.1; 210/321.6; 210/170.11; 210/263; 210/322; 210/175; 210/170.01; 210/252; 210/747; 210/652

(57) ABSTRACT

An apparatus (10) for treating a fluid to be injected into a subterranean hydrocarbon-bearing formation comprises a desalination system (12) having a fluid inlet (16) for receiving a first feed fluid (18) and a first fluid outlet (22) for delivering a first product fluid (20). The apparatus (10) also includes a selective ionic species removal plant (30) having a fluid inlet (36) for receiving a second feed fluid (34) and a fluid outlet (40) for delivering a second product fluid (38), wherein the second product fluid (38) has a preferred ionic concentration. A mixer (46) is provided for mixing at least a portion of the first product fluid (20) and at least a portion of the second product fluid (38) to provide a third or injection product fluid (48). Accordingly, injection fluid can be created which has a preferred ionic concentration suitable for injecting into a well (28).

### FIELD OF THE INVENTION

The present invention relates to an apparatus and method for treating an injection fluid, and in particular, but not exclusively, to an apparatus and method for filtering and treating water to be injected into a subterranean hydrocarbon-bearing formation.

### BACKGROUND OF THE INVENTION

Extracting hydrocarbons from a subterranean formation involves flowing hydrocarbons from the formation to surface through a production well bore. In the early stages of production, the hydrocarbons are driven into the production well and flowed to surface by pressure within the formation. However, over time the formation pressure reduces until natural extraction can no longer be sustained, at which stage some form of artificial or assisted extraction is required. One common form of artificial extraction involves the injection of a fluid medium into the depleting formation through an injection well bore which extends from surface in order to displace the hydrocarbons from the formation. Conventionally, the fluid medium is aqueous and may be produced water or sea water or the like. Fluid injection in this manner may also be utilised as a form of matrix support in order to prevent collapse of the reservoir after the hydrocarbons have been removed.

Where water injection is utilised to displace hydrocarbons from the formation, or provide matrix support, it is important that the injection water is compatible with the formation chemistry and is substantially free from suspended or dissolved particles and colloidal and macromolecular matter. This is required to prevent or at least minimise plugging of the formation and associated wells, which occurs when precipitates or suspended particles or the like accumulate and block, or plug, fluid passageways. Such fluid passageways may include pores, fractures, cracks or the like in the hydrocarbon-bearing rock formation, or passageways defined by production and injection well bores. This plugging can significantly reduce hydrocarbon production and in severe cases can terminate production altogether.

In order to ensure that the injection fluid or water is substantially free from suspended or dissolved particles and the like, it is known in the art to treat the water prior to injection into the formation. Treatment normally includes a combination of chemical and mechanical or physical processes. For example, coagulants or flocculants may be added to the water to encourage flocculation where heavy particles or flocculus, known as “floc”, are formed. The floc may then be removed by sedimentation and/or by filtration whereby mechanical straining removes a proportion of the particles by trapping them in the filter medium. Conventional filtration apparatus for use in treating injection water to remove such particulate material include multimedia filters which consist of two or more layers of different or graded granular material such as gravel, sand and anthracite, for example. The fluid or water to be treated is passed through the filter and any suspended or dissolved particles or the like will be retained in the interstices between the granules of the different layers.

With regards to plugging caused by precipitate formation and accumulation, this occurs when ionic species in the injection fluid or water combines or reacts with compatible ionic species in water present in the formation producing a precipitate or scale. For example, divalent sulphate anions (SO₄²⁻) in the injection water will combine with various cations which may be present in the formation water to form substantially insoluble precipitates. For example, the formation water may contain, among others: barium cations (Ba²⁺), which when combined with sulphate produces a barium-sulphate or barite precipitate; strontium cations (Sr²⁺) resulting in the formation of a strontium-sulphate precipitate; or calcium cations (Ca²⁺) resulting in the formation of a calcium-sulphate or anhydrite precipitate or scale. As noted above, these resultant precipitates are substantially insoluble, particularly barite, making any precipitate purging and removal/squeezing process extremely difficult, complicated and expensive.

Additionally, the presence of sulphate in the injection fluid or water provides a source of sulphur which thermophilic sulphate reducing bacteria (SRB) that may be present in the formation feed on, producing hydrogen-sulfide (H₂S) which causes souring of the well. Hydrogen-sulfide is extremely corrosive and specialised equipment must be used to accommodate the “sour” hydrocarbons, both at the extraction/production stage and at the processing stage. Using injection water with a high sulphate content can therefore sour an originally “sweet” well.

Various methods have been proposed to provide a preventative solution by removing the problematic, or precursor divalent ions from the injection water before injection into the formation. For example, prior art reference U.S. Pat. No. 4,723,603 discloses a process in which a feed water is treated to remove precursor ions by a process of reverse osmosis to produce a treated injection water product.

It is often the case, however, that an ionic species is preferably retained, and that the concentration of an ionic species be controlled. For example, the presence of monovalent ions, such as chloride, sodium and potassium ions, within injection water may have a beneficial effect on the formation, for example by assisting to stabilise clays and the like. However, where reverse osmosis is utilised to treat injection water this generally substantially excludes the majority of ions from the water, such that the treated injection water may have a concentration of a particular ionic species which is too low. Furthermore, in filtration operations, such as nanofiltration, which generally permit the passage of monovalent ions, it is difficult to control the output concentration of such ions to within the required degree, and depends on factors such as the ionic concentration of feed water, flux efficiency of the filtration media, temperature, feed pressure, pH, and the like.

It is among objects of embodiments of the present invention to obviate or at least mitigate problems associated with prior art methods of treating a fluid for injection into a hydrocarbon bearing formation.

### SUMMARY OF THE INVENTION

According to a first aspect of the present invention, there is provided an apparatus for treating a fluid to be injected into a subterranean hydrocarbon-bearing formation, said apparatus comprising:

a desalination system having a fluid inlet for receiving a first feed fluid and a first fluid outlet for delivering a first product fluid;

a selective ionic species removal plant having a fluid inlet for receiving a second feed fluid and a fluid outlet for delivering a second product fluid; and

mixing means for mixing at least a portion of the first product fluid and at least a portion of the second product fluid to provide a third product fluid.

Advantageously, in use, the apparatus is adapted to provide the third product fluid having a preferred ionic species concentration, which concentration may be readily controlled and adapted to accommodate specific product requirements. Preferably, the third product fluid is provided to be injected into a hydrocarbon bearing formation.

Preferably, the desalination system is adapted to provide the first product fluid having a lower chemical salt concentration than the first feed fluid.

Advantageously, the desalination system may be adapted to receive the first feed fluid comprising at least monovalent ionic species, and in use the desalination system may be adapted to reject a substantial portion of said monovalent ionic species from the first feed fluid. In a preferred embodiment, the first feed fluid comprises at least monovalent ionic species, such as chloride ions, sodium ions and potassium ions, and divalent ionic species, such as sulphate anions, and the desalination system is adapted to reject a substantial portion of said monovalent and divalent ionic species from the first feed fluid. The desalination system is preferably adapted to reject a substantial portion of all ionic species from the first feed fluid such that the ionic concentration of the first product fluid is lower than the ionic concentration of the first feed fluid.

Preferably, the desalination system comprises a second fluid outlet for delivering a concentrate stream therefrom, wherein the concentrate stream has a higher chemical salt concentration than the first feed fluid.

In one embodiment of the present invention the desalination system comprises a thermal separator, such as an evaporator, for example a multiple effect distillation plant or a flash desalination plant or the like, or any suitable combination thereof.

Alternatively, or additionally, the desalination system comprises a reverse osmosis filtration system comprising one or more reverse osmosis membranes which may be arranged in any conventional manner. In a preferred embodiment the reverse osmosis filtration system operates in a cross-flow mode thus producing a concentrate stream having an elevated ionic species concentration.

Preferably, the selective ionic species removal plant is adapted to receive the second feed fluid comprising at least two ionic species, wherein the selective ionic species removal plant is adapted to reject a substantial portion of at least one ionic species from the second feed fluid, while permitting a substantial portion of at least one other, preferred, ionic species to pass to the second product fluid. Accordingly, the second product fluid advantageously has a lower concentration of at least one ionic species than the concentration of the same ionic species present in the second feed fluid, while maintaining substantially the same concentration of the preferred ionic species.

This arrangement therefore provides a second product fluid having a low concentration of at least one ionic species while having a relatively higher concentration of at least one preferred ionic species.

The concentration of the preferred ionic species in the second product fluid may be readily determined by conventional methods. Accordingly, a specified volume of the second product fluid may be mixed with a specified volume of the first product fluid to produce the third product fluid having a predetermined concentration of the preferred ionic species, while having a low concentration of those ionic species rejected by the selective ionic species removal plant. In this manner, the third product fluid may be appropriately and accurately conditioned in terms of ionic concentration to be compatible with formation fluids within the well into which the third product fluid is to be injected.

Preferably, the selective ionic species removal plant is a sulphate removal plant. Preferably also, the ionic species removal plant comprises at least one and preferably a plurality of nano-filtration membranes, preferably adapted to reject divalent sulphate anions (SO₄²⁻) while allowing monovalent ions to pass therethrough. The nano-filtration membranes may permit ions such as sodium ions, chloride ions and potassium ions, for example, to pass therethrough, wherein such ions may have a beneficial effect on the formation by stabilising clays and the like.

In one embodiment, the first feed fluid may comprise seawater. Alternatively, or additionally, the first feed fluid may comprise brine or produced water from a subterranean source, such as from a hydrocarbon bearing formation.

The second feed fluid may comprise seawater and/or produced water. Preferably, the second feed water alternatively, or additionally, comprises the concentrate stream from the second fluid outlet of the desalination system.

Advantageously, the apparatus may comprise a first filtration unit having a filtration media adapted to filter the first feed fluid prior to being delivered to the desalination plant. Accordingly, any colloids, flocculants, particulates and high molecular mass soluble species and the like will be retained by the filtration media by a mechanism of size exclusion to concentrate, fraction or filter dissolved or suspended species within the first feed fluid. The first filtration unit therefore assists to prevent fouling of the desalination plant by particles and colloids and the like. The filtration media may comprise particulate material, such as sand, which may be of uniform size or may alternatively be graded. Alternatively, the first filtration unit may comprise at least one and preferably a plurality of filtration membranes, most preferably ultra or micro filtration membranes.

The apparatus may further comprise a second filtration unit adapted to filter the second feed fluid prior to being delivered to the ionic species removal plant. The second filtration unit may be similar to the first filtration unit.

According to a second aspect of the present invention there is provided a method of treating fluid to be injected into a subterranean hydrocarbon-bearing formation, said method comprising the steps of:

flowing a first feed fluid through a desalination system to produce a first product fluid;

flowing a second feed fluid through a selective ionic species removal plant to produce a second product fluid having a known ionic species concentration; and

mixing at least a portion of the first product fluid with at least a portion of the second product fluid to provide a third product fluid.

Preferably, the third product fluid is adapted to be injected into a hydrocarbon bearing formation. Accordingly, the third product fluid may be provided which has a predetermined ionic concentration preferably compatible with formation fluids within the hydrocarbon bearing formation.

Preferably, the second feed fluid comprises a concentrate stream delivered from the desalination system.

Preferably, the ionic species removal plant is a sulphate removal plant for removing divalent sulphate ions from the injection fluid. Preferably also, the ionic species removal plant comprises at least one nano-filtration membrane.

Advantageously, the method further involves the step of flowing at least the first feed fluid through a filtration unit prior to being delivered to the desalination system.

According to a third aspect of the present invention, there is provided an injection system for injecting fluid into a subterranean hydrocarbon-bearing formation, said system comprising:

a desalination system having a fluid inlet for receiving a first feed fluid and a first fluid outlet for delivering a first product fluid;

a selective ionic species removal plant having a fluid inlet for receiving a second feed fluid and a fluid outlet for delivering a second product fluid;

mixing means for mixing at least a portion of the first product fluid and at least a portion of the second product fluid to provide a third product fluid; and

injection pump means adapted for pressurising the third product fluid to be injected into a hydrocarbon-bearing formation.

Preferably, the ionic species removal plant is a sulphate removal plant.

According to a fourth aspect of the present invention, there is provided an apparatus for treating a fluid to be injected into a subterranean hydrocarbon-bearing formation, said apparatus comprising:

an ionic species removal plant having a fluid inlet for receiving a first feed fluid and a first fluid outlet for delivering a first product fluid having a lower ionic concentration than the first feed fluid;

a selective ionic species removal plant having a fluid inlet for receiving a second feed fluid and a fluid outlet for delivering a second product fluid having a lower concentration of a specific ionic species than the second feed fluid; and

mixing means for mixing at least a portion of the first product fluid and at least a portion of the second product fluid to provide a third product fluid.

### BRIEF DESCRIPTION OF THE DRAWINGS

These and other aspects of the present invention will now be described, by way of example only, with reference to the accompanying drawings, in which:

FIG. 1 is a diagrammatic representation of an embodiment of an apparatus for treating water to be injected into a hydrocarbon-bearing formation according to the present invention;

FIG. 2 is a diagrammatic representation of an alternative embodiment of an apparatus for treating water to be injected into a hydrocarbon-bearing formation according to the present invention; and

FIG. 3 is a diagrammatic representation of a further alternative embodiment of an apparatus for treating water to be injected into a hydrocarbon-bearing formation according to the present invention.

### DETAILED DESCRIPTION OF THE DRAWINGS

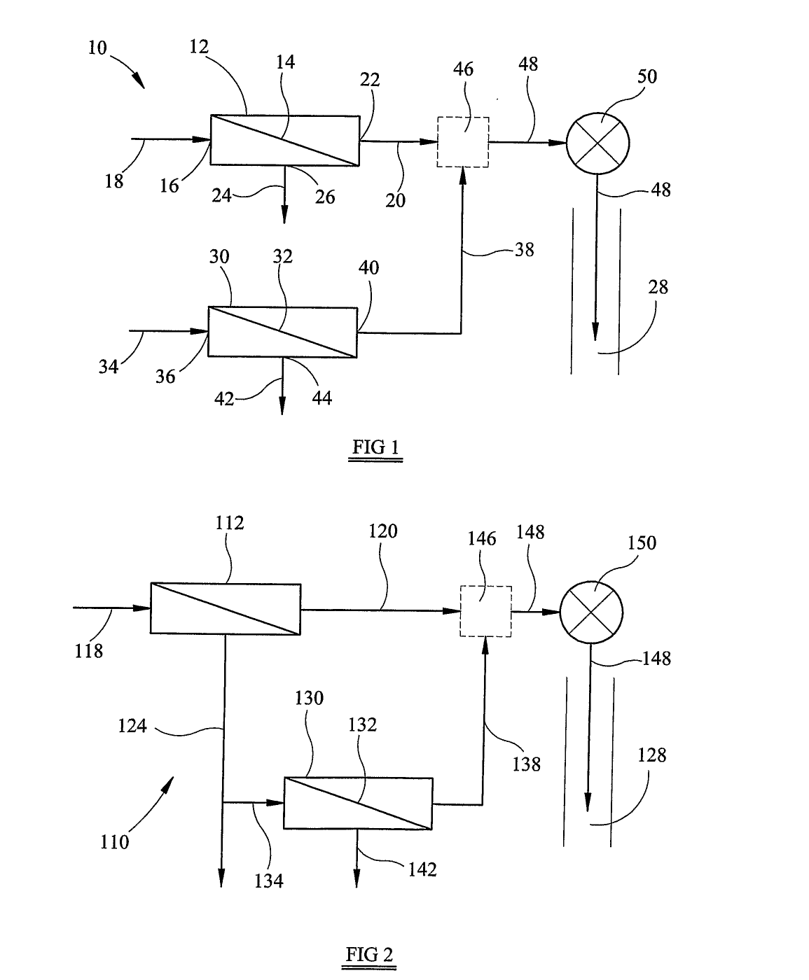

Referring initially to FIG. 1, there is shown a diagrammatic representation of a water treatment apparatus or system 10 in accordance with an embodiment of the present invention. The system 10 comprises a desalination system, which in the embodiment shown is a reverse osmosis plant 12 having a plurality of reverse osmosis membranes, generally represented by reference numeral 14. The reverse osmosis plant defines a fluid inlet 16 for receiving a feed fluid 18 from a fluid source (not shown), which may be seawater or brine produced from a subterranean formation. The membranes 14 are arranged to operate in a cross-flow mode such that a first product fluid stream 20 is created and delivered from a first fluid outlet 22, and a concentrate fluid stream 24 is created and delivered from a second fluid outlet 26. By virtue of the reverse osmosis plant 12 and membranes 14, the produced fluid 20 has a significantly less ionic concentration than that of the feed fluid 18. In this respect it should be noted that the reverse osmosis plant 12 rejects both monovalent and divalent ions from the feed fluid 18. Thus, in many circumstances the concentration of certain ionic species in the product stream 20 may be too low to be directly injected into a well bore 28. The treatment system 10 provides a means of controlling the level of certain ionic species within an injection fluid prior to being injected into a well 28, as will be discussed in detail below. In the embodiment shown in FIG. 1, the high ionic concentration concentrate stream 24 may be disposed of.

The system 10 further comprises a selective ionic species removal plant which in the embodiment shown is in the form of a sulphate removal plant 30 which comprises a plurality of nano-filtration membranes, generally represented by numeral 32. A feed fluid stream 34, which may be seawater or brine or the like, is fed to the sulphate removal plant 30 through fluid inlet 36. As in the reverse osmosis plant 12, the membranes 32 in the sulphate removal plant 30 operate in a cross-flow mode thus creating a product fluid stream 38 through a first fluid outlet 40 and a concentrate stream 42 through a second fluid outlet 44. The nano-filtration membranes 32 are adapted to reject sulphate anions (SO₄²⁻) while allowing monovalent ions, such as sodium ions, chloride ions and potassium ions to pass therethrough. Accordingly, the product stream 38 will consist of water with a relatively high concentration of ions which may be beneficial to a subterranean formation, for example as they may assist to stabilise formation clays and the like, yet with a low concentration of sulphate anions which prevents the formation of insoluble precipitates within the well if present in the injection fluid.

The product stream 38 with the beneficial ion concentration is subsequently mixed with the low ion concentration product stream 20 from the reverse osmosis plant 12, with mixing of the product streams 20, 38 being generally represented by reference numeral 46, to provide a third or injection product stream 48. More specifically, the concentration of preferred and beneficial ions within product stream 38 may be readily determined in a conventional manner, for example by using ion meters or the like, and from this a precise requisite volume of product stream 38 may be determined and then mixed with product stream 20 to create an injection stream 48 with the necessary ion concentration for compatibility with the well 28. In particular, the injection stream 48 will advantageously contain the necessary concentration of preferred monovalent ions such as chloride ions, while containing minimal sulphate ions. This arrangement therefore permits precise control of the ionic concentration of injection fluid to permit the injection fluid to be compatible with the formation.

The injection stream 48 may be pressurised and injected into the well 28 by an injection pump 50.

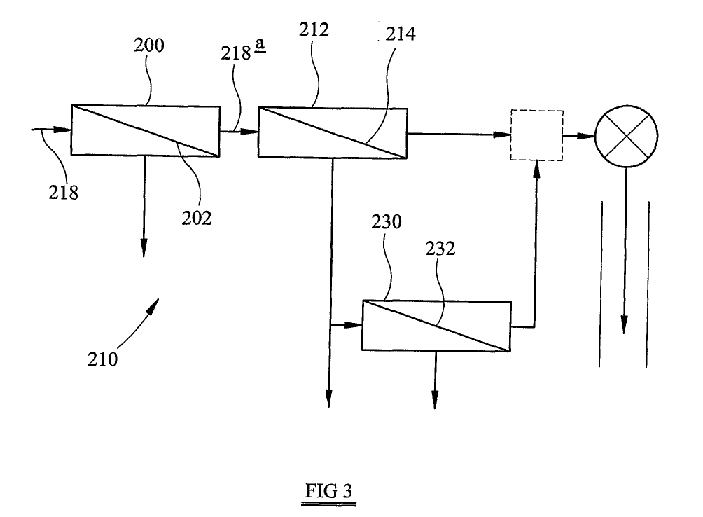

Reference is now made to FIG. 2 in which there is shown a diagrammatic representation of a water treatment system 110 in accordance with an alternative embodiment of the present invention. The system 110 is similar to the system 10 of FIG. 1, and as such like components share like reference numerals, incremented by 100. The system 110 also comprises a reverse osmosis plant producing a product fluid 120 and a concentrate stream 124 from a fluid source stream 118. Also, the system 110 comprises a nano-filtration sulphate removal plant 130 producing a product stream 138 and a concentrate stream 142 from a fluid source stream 134. However, in this embodiment the fluid source stream 134 is provided from the concentrate stream 124 from the reverse osmosis plant 112. In this way, the source stream 134 will have a high concentration of ions which are advantageously permitted to pass through the nano-filtration membranes 132 within the sulphate removal plant 130, thus providing a product stream 138 with a corresponding high concentration of these ions.

The product streams 120, 138 from the reverse osmosis plant 112 and sulphate removal plant 130 may then be mixed together, represented by numeral 146, in the desired quantities to provide an injection stream 148 with the necessary ionic concentration. This injection stream may then be injected into the well 128 via injection pump 150.

A further alternative embodiment of a water treatment system 210 is shown diagrammatically in FIG. 3, reference to which is now made. The system 210 is almost identical to the system 110 shown in FIG. 2, and as such like components share like reference numerals, incremented by 100. In the present system 210, the feed source stream 218 supplied to the reverse osmosis plant 212 is first passed through a filtration unit 200 which comprises a plurality of filtration membranes, generally identified by reference numeral 202. The membranes 202 may comprise ultra-filtration membranes, micro-filtration membranes or the like, or any combination thereof. The feed fluid 218 is forced through the bank of membranes 202 such that any colloids, flocculants, particulates and high molecular mass soluble species and the like will be retained by the membranes 202 by a mechanism of size exclusion to concentrate, fraction or filter dissolved or suspended species within the fluid 218 to produce a filtered fluid 218a which is directed to the reverse osmosis plant 212. This arrangement assists to prevent fouling of the membranes 214 within the reverse osmosis plant 212 and the membranes 232 within the sulphate removal plant 230.

Although not shown, in each embodiment shown above the fluid may be pressure driven across each of the reverse osmosis plant and sulphate removal plant by suitable pump arrangements, which may be positive pressure pumps or vacuum pumps.

It should be understood that the embodiments described are merely exemplary of the present invention and that modifications may be made thereto without departing from the scope of the invention. For example, the arrangements shown may be utilised to provide a fluid stream with a desired ionic concentration to be used in an alternative process and may not be restricted for use in well bore injection applications. Additionally, the reverse osmosis plant in each embodiment may be replaced with a thermal desalination plant, such as a multiple effect distillation plant, flash distillation plant or the like, or any suitable combination thereof. Additionally, the systems shown may comprise a backwashing or other cleaning system to clean the membranes within the reverse osmosis and sulphate removal plants. Furthermore, the systems disclosed may also comprise a deaerator in order to remove oxygen and other gases from the fluid being treated.

1. An apparatus for treating a fluid to be injected into a subterranean hydrocarbon-bearing formation, said apparatus comprising:
a desalination system having a fluid inlet for receiving a first feed fluid and a first fluid outlet for delivering a first product fluid;
a selective ionic species removal plant having a fluid inlet for receiving a second feed fluid and a fluid outlet for delivering a second product fluid; and
mixing means for mixing at least a portion of the first product fluid and at least a portion of the second product fluid to provide a third product fluid.

2. The apparatus of claim 1, wherein the mixing means is adapted to provide a third product fluid having a preferred ionic species concentration.

3. The apparatus of claim 2, wherein the third product fluid is provided from the mixing means to be injected into a hydrocarbon bearing formation.

4. The apparatus of claim 1, wherein the desalination system is adapted to provide the first product fluid having a lower chemical salt concentration than the first feed fluid.

5. The apparatus of claim 1, wherein the desalination system is adapted to receive the first feed fluid comprising at least monovalent ionic species, and in use the desalination system is adapted to reject a substantial portion of said monovalent ionic species from the first feed fluid.

6. The apparatus of claim 1, wherein the first feed fluid comprises at least monovalent ionic species and divalent ionic species, and the desalination system is adapted to reject a substantial portion of said monovalent and divalent ionic species from the first feed fluid.

7. The apparatus of claim 1, wherein the desalination system comprises a second fluid outlet for delivering a concentrate stream therefrom, wherein the concentrate stream has a higher chemical salt concentration than the first feed fluid.

8. The apparatus of claim 1, wherein the desalination system comprises a thermal separator.

9. The apparatus of claim 1, wherein the desalination system comprises a reverse osmosis filtration system comprising at least one reverse osmosis membrane.

10. The apparatus of claim 1, wherein the selective ionic species removal plant is adapted to receive the second feed fluid comprising at least two ionic species, wherein the selective ionic species removal plant is adapted to reject a substantial portion of at least one ionic species from the second feed fluid, while permitting a substantial portion of at least one other, preferred, ionic species to pass to the second product fluid.

11. The apparatus of claim 10, wherein a specified volume of the second product fluid is mixed with a specified volume of the first product fluid to produce the third product fluid having a predetermined concentration of the preferred ionic species

12. The apparatus of claim 1, wherein the selective ionic species removal plant is a sulphate removal plant.

13. The apparatus of claim 1, wherein the ionic species removal plant comprises at least one nano-filtration membrane.

14. The apparatus of claim 13, wherein the nano-filtration membrane is adapted to reject divalent sulphate anions (SO₄²⁻) while allowing monovalent ions to pass therethrough.

15. The apparatus of claim 1, wherein the first feed fluid comprises seawater.

16. The apparatus of claim 1, wherein the first feed fluid comprises brine or produced water from a subterranean source.

17. The apparatus of claim 1, wherein the second feed fluid comprises seawater.

18. The apparatus of claim 1, wherein the second feed fluid comprises brine or produced water from a subterranean source.

19. The apparatus of claim 1, wherein the second feed water comprises a concentrate stream from the second fluid outlet of the desalination system.

20. The apparatus of claim 1, further comprising a first filtration unit having a filtration media adapted to filter the first feed fluid prior to being delivered to the desalination plant.

21. The apparatus of claim 20, wherein the filtration media comprises particulate material.

22. The apparatus of claim 20, wherein the first filtration unit the filtration media comprises at least one filtration membrane.

23. The apparatus of claim 1, further comprising a second filtration unit adapted to filter the second feed fluid prior to being delivered to the ionic species removal plant.

24. A method of treating fluid to be injected into a subterranean hydrocarbon-bearing formation, said method comprising the steps of:
flowing a first feed fluid through a desalination system to produce a first product fluid;
flowing a second feed fluid through a selective ionic species removal plant to produce a second product fluid having a known ionic species concentration; and
mixing at least a portion of the first product fluid with at least a portion of the second product fluid to provide a third product fluid.

25. The method of claim 24, wherein the third product fluid is adapted to be injected into a hydrocarbon bearing formation.

26. The method of claim 24, wherein the second feed fluid comprises a concentrate stream delivered from the desalination system.

27. The method of claim 24, wherein the ionic species removal plant comprises a sulphate removal plant for removing divalent sulphate ions from the injection fluid.

28. The method of claim 24, wherein the ionic species removal plant comprises at least one nano-filtration membrane.

29. The method of claim 24, further comprising the step of flowing at least the first feed fluid through a filtration unit prior to being delivered to the desalination system.

30. An injection system for injecting fluid into a subterranean hydrocarbon-bearing formation, said system comprising:
a desalination system having a fluid inlet for receiving a first feed fluid and a first fluid outlet for delivering a first product fluid;
a selective ionic species removal plant having a fluid inlet for receiving a second feed fluid and a fluid outlet for delivering a second product fluid;
mixing means for mixing at least a portion of the first product fluid and at least a portion of the second product fluid to provide a third product fluid; and
injection pump means adapted for pressurising the third product fluid to be injected into a hydrocarbon-bearing formation.

31. The system of claim 30, wherein the ionic species removal plant comprises a sulphate removal plant.

32. An apparatus for treating a fluid to be injected into a subterranean hydrocarbon-bearing formation, said apparatus comprising:
an ionic species removal plant having a fluid inlet for receiving a first feed fluid and a first fluid outlet for delivering a first product fluid having a lower ionic concentration than the first feed fluid;
a selective ionic species removal plant having a fluid inlet for receiving a second feed fluid and a fluid outlet for delivering a second product fluid having a lower concentration of a specific ionic species than the second feed fluid; and
mixing means for mixing at least a portion of the first product fluid and at least a portion of the second product fluid to provide a third product fluid.
